(19) United States
(12) Patent Application Publication
(10) Pub. No.: US 2012/0247298 A1
(43) Pub. Date: Oct. 4, 2012

(54) CUTTING APPARATUS AND HOLDING MEMBER FOR HOLDING OBJECT TO BE CUT

(75) Inventors: Tomoyasu Niizeki, Ichinomiya-shi (JP); Yasuhiko Kawaguchi, Nagoya-shi (JP); Yoshinori Nakamura, Toyohashi-shi (JP); Masahiko Nagai, Nagoya-shi (JP); Katsuhisa Hasegawa, Kasugai-shi (JP)

(73) Assignee: BROTHER KOGYO KABUSHIKI KAISHA, Nagoya-shi (JP)

(21) Appl. No.: 13/431,233

(22) Filed: Mar. 27, 2012

(30) Foreign Application Priority Data
Mar. 30, 2011 (JP) 2011-075581

(51) Int. Cl. B26D 7/01

(52) U.S. Cl. 83/467.1

(57) ABSTRACT

A cutting apparatus is disclosed in which a cutting blade and an object to be cut are moved relative to each other so that the object is cut by the butting blade. The cutting apparatus includes a holding member which is inserted into the cutting apparatus while holding the object and a supporting member which abuts on the holding member in a direction which differs from an insertion direction in which the holding member is inserted into the cutting apparatus, supporting the holding member. The holding member has a supported portion which is supported by the supporting member and provided with an inclined portion which is inclined to the insertion direction. The holding member is configured so that the inclined portion initially abuts on the supported portion.

### CROSS-REFERENCE TO RELATED APPLICATIONS

This application is based upon and claims the benefit of priority from the prior Japanese Patent Application No. 2011-075581 filed on Mar. 30, 2011, the entire contents of which are incorporated herein by reference.

### BACKGROUND

1. Technical Field

The present disclosure relates to a cutting apparatus in which a cutting blade and an object to be cut are moved relative to each other so that the object is cut by the cutting blade and a holding member which is inserted into the cutting device while holding the object.

2. Related Art

There has conventionally been known a cutting plotter which automatically cuts a sheet such as paper, for example. In the cutting plotter, a sheet such as paper is attached to a base (corresponding to a holding member) having an adhesive layer on a surface thereof. Both ends of the base are inserted between a driving roller and a pinch roller of a drive mechanism from above and below thereby to beheld therebetween so that the base is moved in a first direction, and a carriage having a cutting blade is moved in a second direction perpendicular to the first direction, thereby cutting a pattern out of the sheet attached to the base.

In the aforementioned cutting plotter, however, there is sometimes a case where a distal end of the base cannot smoothly be inserted between the driving roller and the pinch roller depending upon a manner of setting the base when the base is set to the cutting plotter.

### SUMMARY

Therefore, an object of the disclosure is to provide a cutting apparatus which can allow a reliable setting of a holding member holding an object to be cut and which can stably move the holder.

The present disclosure provides a cutting apparatus which includes an apparatus body and wherein a cutting blade and an object to be cut are moved relative to each other so that the object is cut by the cutting blade, the cutting apparatus comprising a holding member which is inserted into the apparatus body while holding the object; and a supporting member which is provided on the apparatus body and abuts on the holding member in a direction which differs from an insertion direction in which the holding member is inserted into the apparatus body, thereby supporting the holding member, wherein the holding member has a supported portion which is supported by the supporting member and provided with an inclined portion which is inclined to the insertion direction; and the holding member is configured so that the inclined portion thereof initially abuts on the supporting member.

### BRIEF DESCRIPTION OF THE DRAWINGS

In the accompanying drawings:

FIG. 1 is a perspective view of the cutting apparatus according to a first embodiment, showing an inner structure thereof;

FIG. 2 is a plan view of the cutting apparatus;

FIG. 3 is a similar to FIG. 2, showing the cutting apparatus to which a holding member (a holding sheet) is set;

FIG. 4 is a perspective view of a cutter holder;

FIG. 5 is a sectional view of the cutter holder with a cutter having been ascended;

FIG. 6 is a view similar to FIG. 5, showing the cutter holder with the cutter having been descended;

FIG. 7 is an enlarged front view of a gear section;

FIG. 8 is an enlarged view of a distal end of the cutter and the vicinity thereof during cutting;

FIG. 9 is a side view of the cutter holder and the vicinity thereof during cutting;

FIGS. 10A and 10B are an enlarged view of a right end of the cutting apparatus and a sectional view taken along line XB-XB in FIG. 2 respectively;

FIGS. 11A and 11B are a front view of a rolling member, a driving roller and a pinch roller and a plan view of the holding member holding a object to be cut, respectively, both views explaining the correspondence relationship between the rolling member and the pinch roller;

FIG. 12 is a view similar to FIG. 1, showing a second embodiment;

FIGS. 13A and 13B are an enlarged plan view of a corner of the holding member holding the object and a longitudinal section taken along line XIIIb-XIIIb, respectively, both showing a third embodiment;

FIG. 14 is a view similar to FIG. 13B, showing a fourth embodiment;

FIG. 15 is a view similar to FIG. 11B, showing a fifth embodiment; and

FIG. 16 is an enlarged front view of the rolling member and the vicinity thereof.

### DETAILED DESCRIPTION

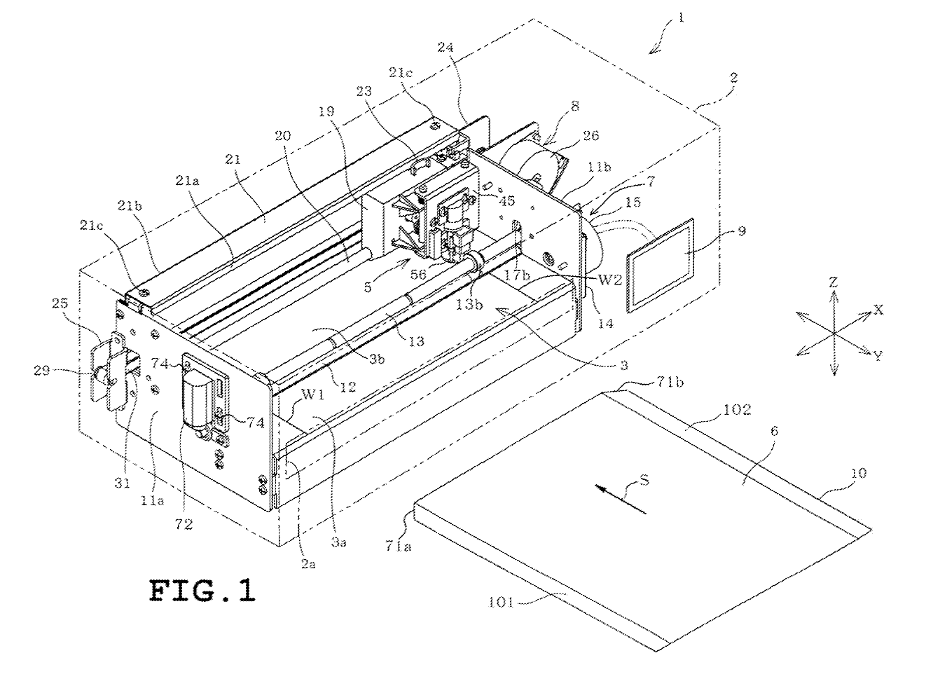

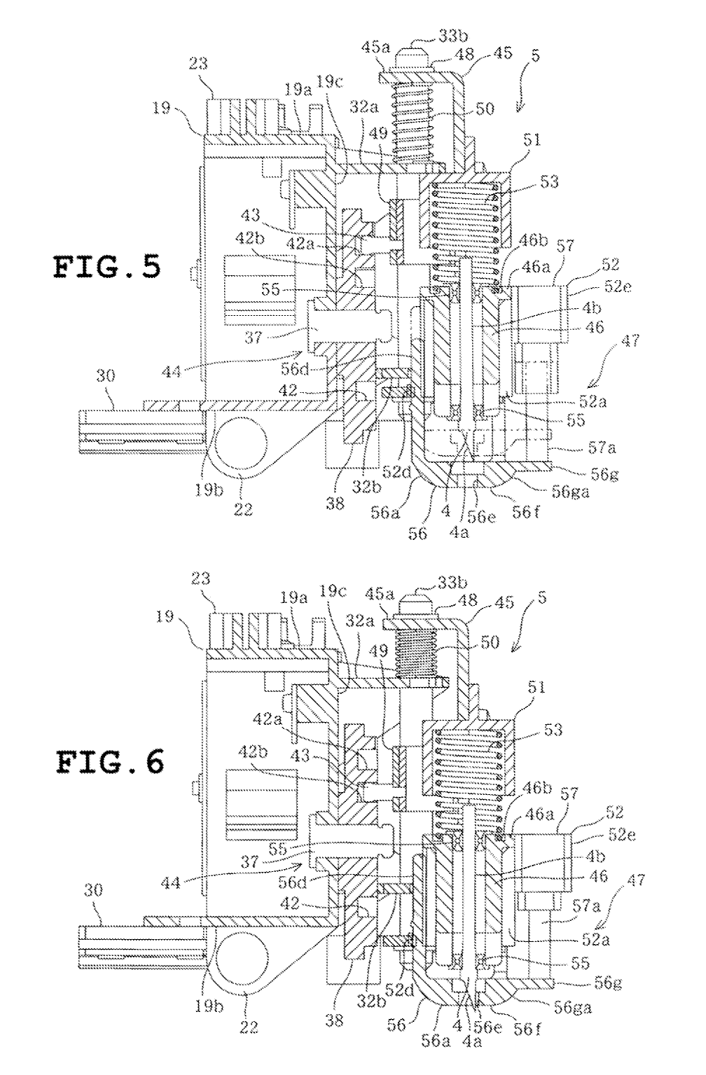

A first embodiment will be described with reference to FIGS. 1 to 11. Referring to FIG. 1, a cutting apparatus 1 includes a body cover 2 as a housing, a platen 3 provided in the body cover 2 and a cutter holder 5. The cutting apparatus 1 also includes first and second moving units 7 and 8 for moving a cutter 4 (see FIG. 5) of the cutter holder 5 and an object 6 to be cut relative to each other. The body cover 2 is formed into the shape of a horizontally long rectangular box and has a front formed with a horizontally long opening 2a for setting a holding sheet 10 holding the object 6. In the following description, the side where the user who operates the cutting apparatus 1 stands will be referred to as “front” with respect to an apparatus body 1a and the opposite side will be referred to as “back.” The front-back direction thereof will be referred to as “Y direction” as shown in FIG. 1. The right-left direction perpendicular to the Y direction'will be referred to as “X direction.”

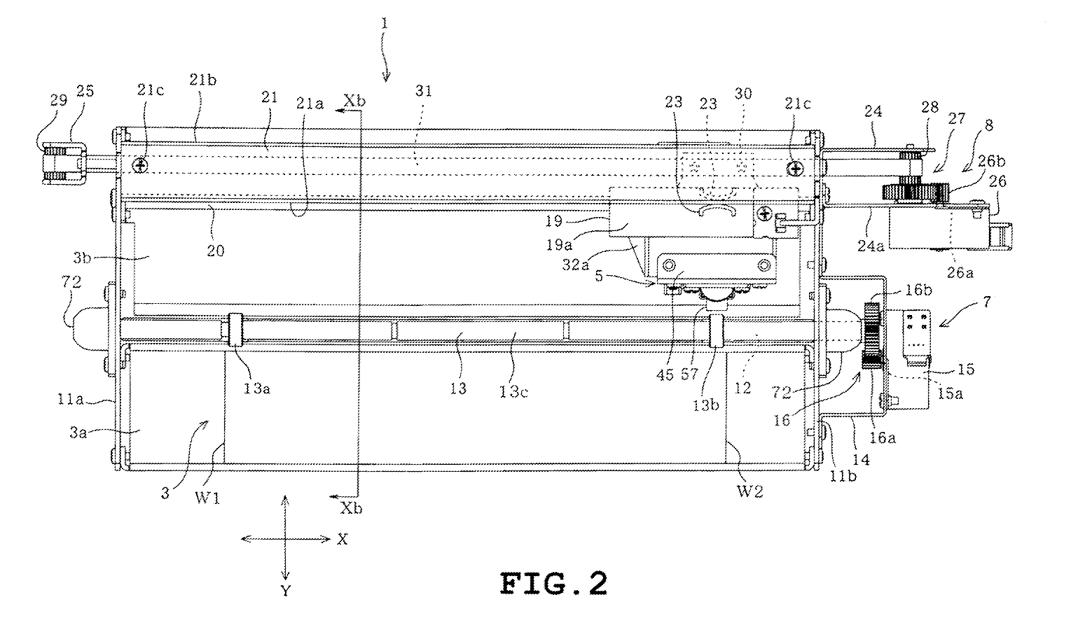

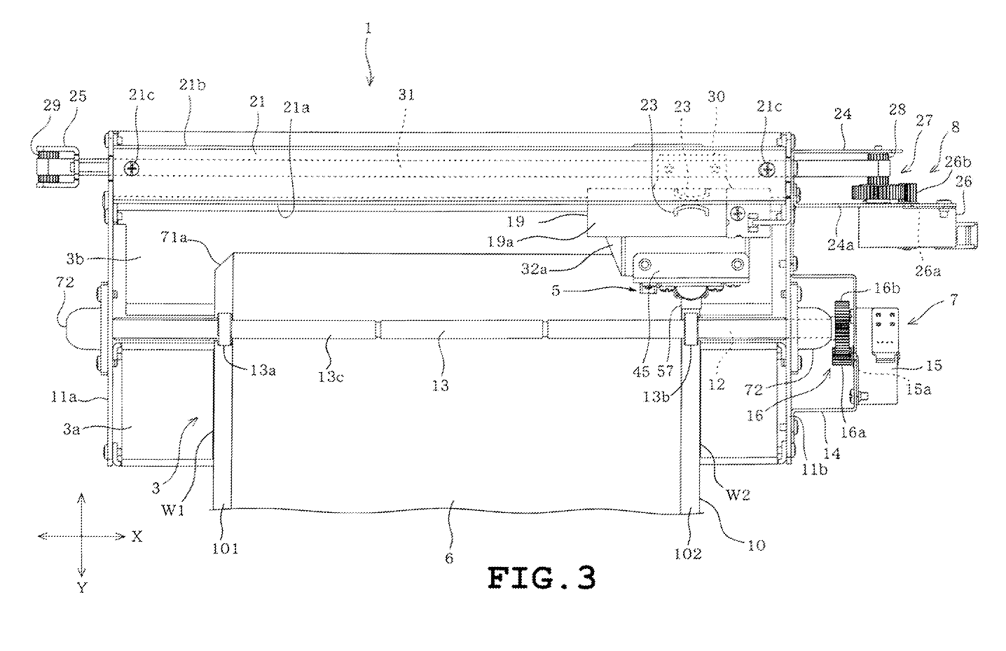

On a right part of the front of the body cover 2 is provided a liquid crystal display (LCD) 9 which serves as a display unit displaying messages and the like necessary for the user. A plurality of operation switches (not shown) is also provided on the right part of the front of the body cover 2. The user operates the operation switches to perform various instructions, selections and input operations. The platen 3 includes a pair of front and rear plate members 3a and 3b and has an upper surface which is configured into an XY plane serving as a horizontal plane. A holding sheet 10 for holding the object 6 is set on the platen 3 so as to be placed on the platen 3. The holding sheet 10 is received by the platen 3 when the object 6 is cut. An adhesive layer 10a to which an adhesive agent is applied is formed on an upper surface of the holding sheet 10 except for right and left edges 101 and 102 of the holding sheet 10 as will be described in detail later. For example, a pair of right and left positioning lines W2 and W1 are provided on an upper surface of the front plate member 3a of the platen 3 as shown in FIGS. 1 and 2. The positioning lines W1 and W2 serve as a positioning unit for positioning the holding sheet 10 with respect to the X direction (the right-left direction). The positioning lines W1 and W2 are formed so that a distance therebetween is substantially equal to or slightly larger than a right-left width of the holding sheet 10 (see FIG. 3). The positioning lines W1 and W2 are viewable through the opening 2a. Accordingly, the positioning lines W1 ad W2 serves as marks (indexes) to position the holding sheet 10 with respect to the X direction.

The first moving unit 7 moves the holding sheet 10 on the upper surface side of the platen 3 in the Y direction (a first direction) More specifically, a driving roller 12 and a pinch roller 13 are provided on right and left sidewalls 11b and 11a so as to be located between plate members 3a and 3b of the platen 3. The concrete construction of the driving roller 12 and pinch roller 13 will be described in detail later.

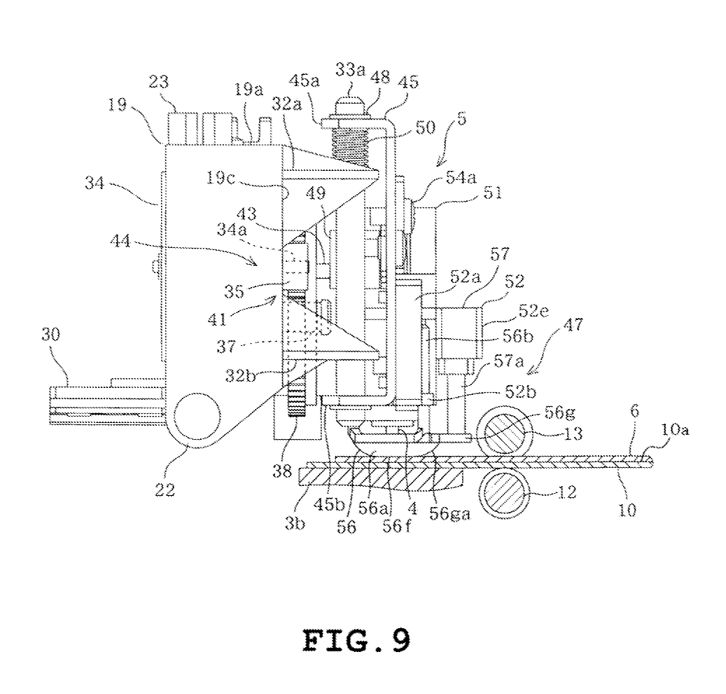

A first crank-shaped mounting frame 14 is provided on the right sidewall 11b so as to be located on the right of the driving roller 12 as shown in FIG. 2. A Y-axis motor 15 is fixed to an outer surface of the mounting frame 14. The Y-axis motor 15 comprises a stepping motor, for example and has a rotating shaft 15a extending through the first mounting frame 14 and further has a distal end provided with a gear 16a. The driving roller 12 has a right end to which is secured another gear 16b which is brought into mesh engagement with the gear 16a. These gears 16a and 16b constitute a first reduction gear mechanism 16. The driving roller 12 and the pinch roller 13 press the holding sheet 10 from below and from above by the urging force of the compression coil springs thereby to hold the holding sheet 10 therebetween (see FIG. 9). Upon drive of the Y-axis motor 15, normal or reverse rotation of the Y-axis motor 15 is transmitted via the first reduction gear mechanism 16 to the driving roller 12, whereby the holding sheet 10 is moved backward or forward together with the object 6. The first moving unit 7 is thus constituted by the driving roller 12, the pinch roller 13, the Y-axis motor 15, the first reduction gear mechanism 16, the compression coil springs and the like.

The second moving unit 8 moves a carriage 19 supporting the cutter holder 5 in the X direction (a second direction). The second moving unit 8 will be described in more detail. A guide shaft 20 and a guide frame 21 both extending in the right-left direction are provided between the right and left sidewalls 11b and 11a so as to be located at the rear end of the cutting apparatus 1, as shown in FIGS. 1 and 2. The guide shaft 20 is disposed in parallel with the driving roller 12 and the pinch roller 13. The guide shaft 20 located right above the platen 3 extends through a lower part of the carriage 19 (a through hole 22 as will be described later). The guide frame 21 has a front edge 21a and a rear edge 21b both folded downward such that the guide frame 21 has a generally C-shaped section. The front edge 21a is disposed in parallel with the guide shaft 20. The guide frame 21 is adapted to guide an upper part (guided members 23 as will be described later) of the carriage 19 by the front edge 21a. The guide frame 21 is fixed to upper ends of the sidewalls 11a and 11b by screws 21c respectively.

A second mounting frame 24 is mounted on the right sidewall 11b in the rear of the cutting apparatus 1, and an auxiliary frame 25 is mounted on the left sidewall 11a in the rear of the cutting apparatus 1, as shown in FIG. 2. An X-axis motor 26 and a second reduction gear mechanism 27 are provided on the second mounting frame 24. The X-axis motor 26 comprises a stepping motor, for example and is fixed to a front of a front mounting piece 24a. The X-axis motor 26 includes a rotating shaft 26a which extends through the mounting piece 24a and has a distal end provided with a gear 26b which is brought into mesh engagement with the second reduction gear mechanism 27. A pulley 28 is rotatably mounted on the second reduction gear mechanism 27, and another pulley 29 is rotatably mounted on the left auxiliary frame 25 as viewed in FIG. 2. An endless timing belt 31 connected to a rear end (a mounting portion 30 as will be described later) of the carriage 19 extends between the pulleys 28 and 29.

Upon drive of the X-axis motor 26, normal or reverse rotation of the X-axis motor 26 is transmitted via the second reduction gear mechanism 27 and the pulley 28 to the timing belt 31, whereby the carriage 19 is moved leftward or rightward together with the cutter holder 5. Thus, the carriage 19 and the cutter holder 5 are moved in the X direction perpendicular to the Y direction in which the object 6 is conveyed. The second moving unit 8 is constituted by the above-described guide shaft 20, the guide frame 21, the X-axis motor 26, the second reduction gear mechanism 27, the pulleys 28 and 29, the timing belt 31, the carriage 19 and the like.

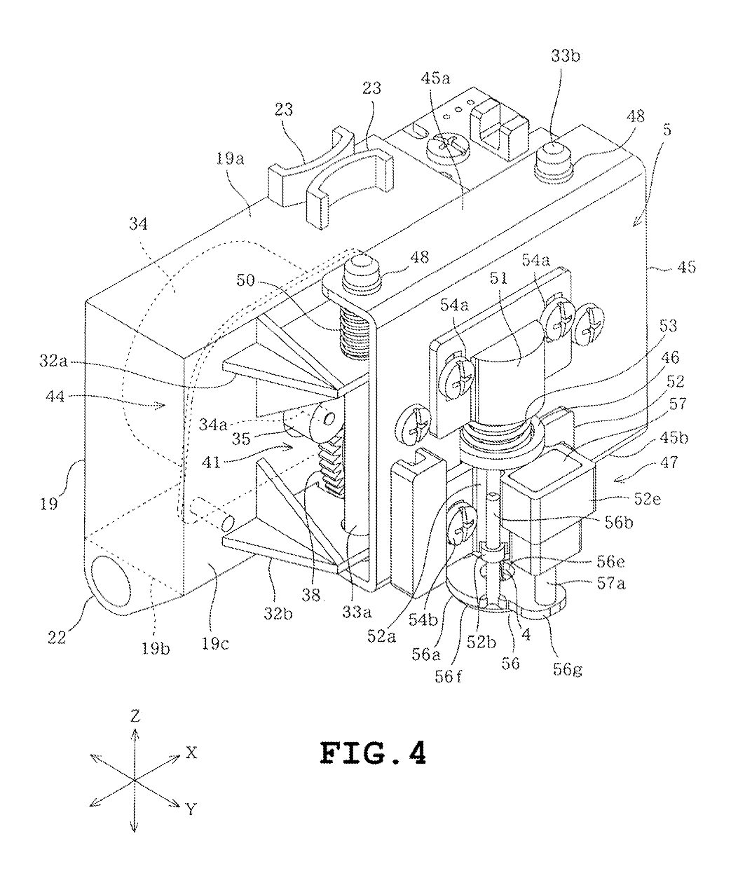

The cutter holder 5 is disposed on the front of the carriage 19 and is supported so as to be movable in a vertical direction (a third direction) serving as a Z direction. The carriage 19 and the cutter holder 5 will be described with reference to FIGS. 4 to 7 as well as FIGS. 1 and 2. The carriage 19 is formed into the shape of a substantially rectangular box with an open rear as shown in FIGS. 2 and 4. The carriage 19 has an upper wall 19a with which a pair of upwardly protruding front and rear guided members 23 are integrally formed. The guided members 23 are arc-shaped ribs as viewed in a planar view. The guided members 23 are symmetrically disposed with a front edge 21a of the guide frame 21 being interposed therebetween. The carriage 19 has a bottom wall 19b further having a downwardly expanding portion which is formed with a pair of right and left through holes 22 through which the guide shaft 20 is inserted, as shown in FIGS. 4 and 5. An attaching portion 30 (see FIGS. 5 and 6) is mounted on the bottom wall 19b of the carriage 19 so as to protrude rearward. The attaching portion 30 is to be coupled with the timing belt 31. The carriage 19 is thus supported by the guide shaft 20 inserted through the holes 22 so as to be slidable in the right-left direction and further supported by the guide frame 21 held between the guided members 23 so as to be prevented from being rotated about the guide shaft 20.

The carriage 19 has a front wail 19c with which a pair of upper and lower support portions 32a and 32b are formed so as to extend forward as shown in FIGS. 4, 9, etc. A pair of right and left support shafts 33b and 33a extending through the respective support portions 32a and 32b are mounted on the carriage 19 so as to be vertically movable. A Z-axis motor 34 comprising, for example, a stepping motor is accommodated in the carriage 19 backward thereby to be housed therein. The Z-axis motor 34 has a rotating shaft 34a (see FIGS. 4 and 9) which extends through the front wall 19c of the carriage 19. The rotating shaft 34a has a distal end provided with a gear 35. Furthermore, the carriage 19 is provided with a gear shaft 37 which extends through a slightly lower part of the gear 35 relative to the central part of the front wall 19c as shown in FIGS. 5, 6 and 9. A gear 38 is rotatably mounted on the gear shaft 37 and adapted to be brought into mesh engagement with the gear 35 in front of the front wall 19c is rotatably mounted on the gear shaft 37. The gear 38 is retained by a retaining ring (not shown) mounted on a front end of the gear shaft 37. The gears 35 and 38 constitute a third reduction mechanism 41 (see FIGS. 4 and 9).

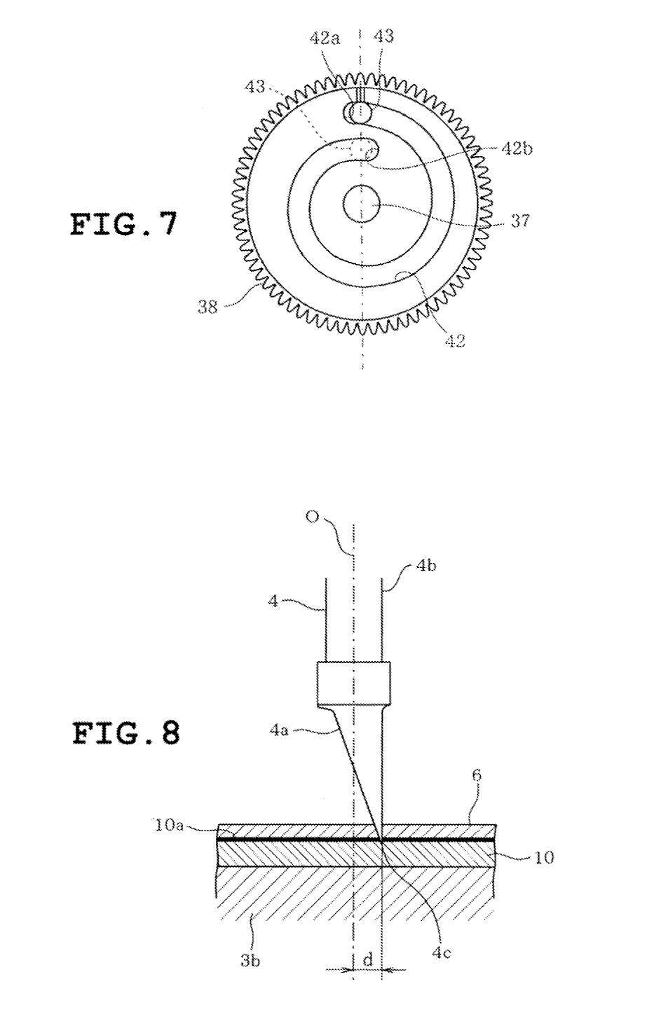

The gear 38 is formed with a spiral groove 42 as shown in FIG. 7. The spiral groove 42 is a cam groove formed into a spiral shape such that the spiral groove 42 comes closer to the center of the gear 38 as it is turned rightward from a first end 42a toward a second end 42b. An engagement pin 43 which is vertically moved together with the cutter holder 5 engages the spiral groove 42 (see FIGS. 5 and 6) as will be described in detail later. Upon normal or reverse rotation of the Z-axis motor 34, the gear 38 is rotated via the gear 35. Rotation of the gear 38 vertically slides the engagement pin 43 in engagement with the spiral groove 42. With the vertical slide of the gear 38, the cutter holder 5 is moved upward or downward together with the support shafts 33a and 33b. In this case, the cutter holder 5 is moved between a raised position (see FIGS. 5 and 7) where the engagement pin 43 is located at the first end 42a of the spiral groove 42 and a lowered position (see FIGS. 6 and 7) where the engagement pin 43 is located at the second end 42b. A third moving unit 44 which moves the cutter holder 5 upward and downward is constituted by the above-described third reduction mechanism 41 having the spiral groove 42, the Z-axis motor 34, the engagement pin 43, the support portions 32a and 32b, the support shafts 33a and 33b, etc.

The cutter holder 5 includes a holder body 45 provided on the support shafts 33a and 33b, a movable cylindrical portion 46 which has a cutter 4 (a cutting blade) and is held by the holder body 45 so as to be vertically movable and a pressing device 47 which presses the object 6. More specifically, the holder body 45 has an upper end 45a and a lower end 45b both of which are folded rearward such that the holder body 45 is generally formed into a C-shape, as shown in FIGS. 4, 5, 9 and the like. The upper and lower ends 45a and 45b are immovably fixed to the support shafts 33a and 33b by retaining rings 48 fixed to upper and lower ends of the support shafts 33a and 33b, respectively. The support shaft 33b has a middle part to which is secured a coupling member 49 provided with a rearwardly directed engagement pin 43 as shown in FIGS. 5 and 6. The holder body 45, support shafts 33a and 33b, the engagement pin 43 and the coupling member 40 are formed integrally with one another as shown in FIGS. 5 and 6. The cutter holder 5 is vertically moved by the third moving unit 44 in conjunction with the engagement pin 43. Furthermore, compression coil springs 50 serving as biasing members are mounted about the support shafts 33a and 33b so as to be located between upper surfaces of the support portion and upper end of the holder body 45, respectively. The entire cutter holder 5 is elastically biased upward by a biasing force of the compression coil springs 50 relative to the carriage 19.

Mounting members 51 and 52 provided for mounting the movable cylindrical portion 46, the pressing device 47 and the like are fixed to the middle portion of the holder body 45 by screws 54a and 54b respectively, as shown in FIG. 4. The lower mounting member 52 is provided with a cylindrical portion 52a (see FIG. 5) which supports the movable cylindrical portion 46 so that the movable cylindrical portion 46 is vertically movable. The movable cylindrical portion 46 has a diameter that is set so that the movable cylindrical portion 46 is brought into a sliding contact with the inner peripheral surface of the cylindrical portion 52a. The movable cylindrical portion 46 has an upper end on which a flange 46a supported on an upper end of the cylindrical portion 52a is formed so as to expand radially outward. A spring shoe 46b is provided on an upper end of the flange 46a. A compression coil spring 53 is interposed between the upper mounting member 51 and the spring shoe 46b of the movable cylindrical portion 46 as shown in FIGS. 5 and 6. The compression coil spring 53 biases the movable cylindrical portion 46 (the cutter 4) to the lower object 6 side while allowing the upward movement of the movable cylindrical portion 46 against the biasing force when an upward force acts on the cutter 4.

The cutter 4 is provided in the movable cylindrical portion 46 so as to extend therethrough in the axial direction. In more detail, the cutter 4 has a round bar-like cutter shaft 4b which is longer than the movable cylindrical portion 46 and a blade 4a integrally formed on a lower end of the cutter shaft 4b. The blade 4a is formed into a substantially triangular shape and has a lowermost blade edge 4c formed at a location offset by a distance d from a central axis O of the cutter shaft 4b, as shown in FIG. 8. The cutter 4 is held by bearings 55 (see FIG. 5) mounted on upper and lower ends of the movable cylindrical portion 46 so as to be rotatably movable about the central axis 4z (the Z axis) in the vertical direction. Thus, the blade edge 4c of the cutter 4 presses an X-Y plane or the surface of the object 6 from the Z direction perpendicular to the X-Y plane. Furthermore, the cutter 4 has a height that is set so that when the cutter holder 5 has been moved to a lowered position, the blade edge 4c passes through the object 6 on the holding sheet 10 but does not reach the upper surface of the plate member 3b of the platen 3, as shown in FIG. 8. On the other hand, the blade edge 4c of the cutter 4 is moved upward with movement of the cutter holder 5 to the raised position, thereby being spaced from the object 6 (see FIG. 5).

Three guide holes 52b, 52c and 52d (see FIGS. 4, 5 and 9) are formed at regular intervals in a circumferential edge of the lower end of the cylindrical portion 52a of the mounting member 52. A pressing member 56 is disposed under the cylindrical portion 52a and has three guide bars 56b, 56c and 56d which are to be inserted into the guide holes 52b to 52d respectively. The pressing member 56 includes a lower part serving as a shallow bowl-shaped pressing portion body 56a. The aforementioned equally-spaced guide bars 56b to 56d are formed integrally on the circumferential end of the top of the pressing portion body 56a. The guide bars 56b to 56d are guided by the respective guide holes 52b to 52d, so that the pressing member 56 is vertically movable. The pressing portion body 56a has a central part formed with a through hole 56e which vertically extends to cause the blade 4a to pass therethrough. The pressing portion body 56a has an underside serving as a contact portion 56f which is brought into contact with the object 6 while the blade 4a is located in the hole 56e. The contact portion 56f is formed into an annular horizontal flat surface and is brought into surface contact with the object 6. The contact portion 56f is made of a fluorine resin such as Teflon® so as to have a lower coefficient of friction, whereupon the contact portion 56f is rendered slippery relative to the object 6.

The pressing portion body 56a has a guide 56g which is formed integrally on the circumferential edge thereof so as to extend forward, as shown in FIGS. 4, 5 and 9. The guide 56g is located in front of and above the contact portion 56f and includes an inclined surface 56ga inclined rearwardly downward to the contact portion 56f side. Consequently, when the holding sheet 10 holding the object 6 is moved rearward relative to the cutter holder 5, the object 6 is guided downward by the guide 56g so as not to be caught by the contact portion 56f.

The mounting member 52 has a front mounting portion 52e for the solenoid 57, integrally formed therewith. The front mounting portion 52e is located in front of the cylindrical portion 52a and above the guide 56g. The solenoid 57 serves as an actuator for vertically moving the pressing member 56 thereby to press the object 6 and constitutes a pressing device 47 (a pressing unit) together with the pressing member 56 and a control circuit 61 which will be described later. The solenoid 57 is mounted on the front mounting portion 52e so as to be directed downward. The solenoid 57 includes a plunger 57a having a distal end fixed to the upper surface of the guide 56g. When the solenoid 57 is driven with the cutter holder 5 occupying the lowered position, the pressing member 56 is moved downward together with the plunger 57a thereby to press the object 6 with a predetermined pressure (see FIG. 9). On the other hand, when the plunger 57a is located above during non-drive of the solenoid 57, the pressing member releases the object 6 from application of the pressing force. When the cutter holder 5 is moved to the raised position during non-drive of the solenoid 57 (see two-dot chain line in FIG. 5), the pressing member 56 is completely spaced from the object 6.

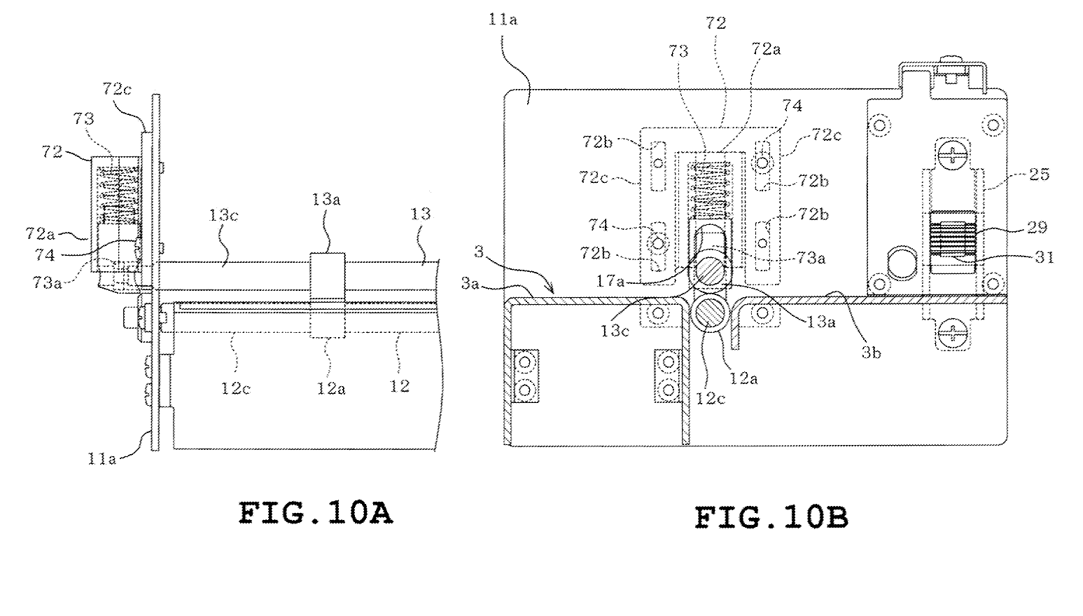

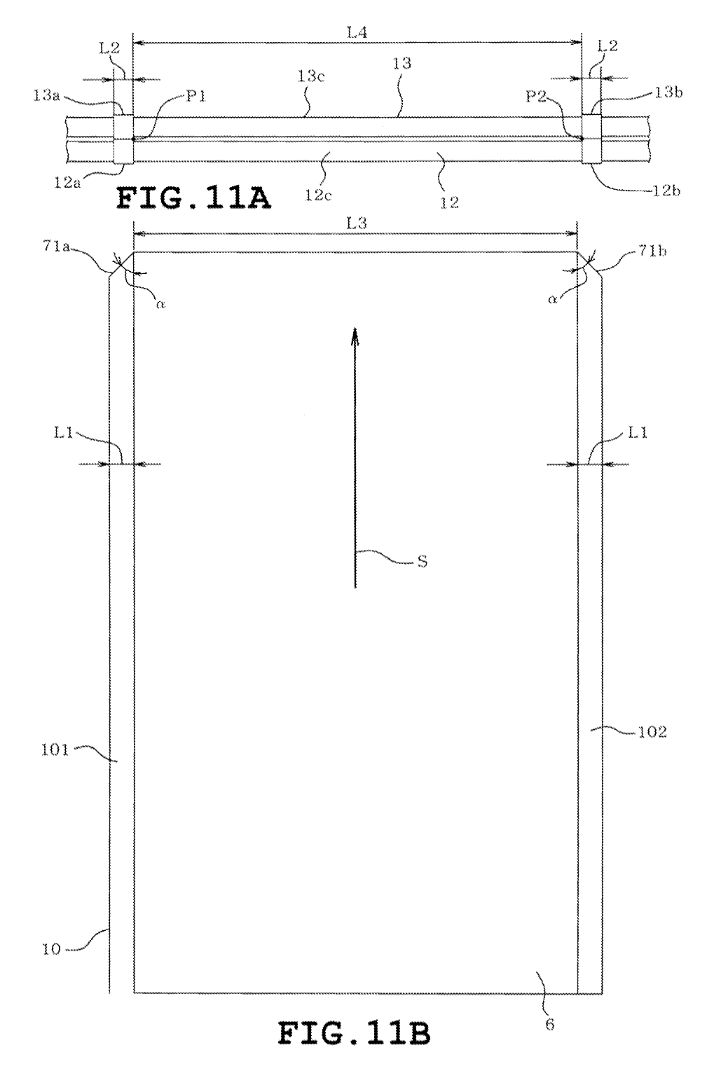

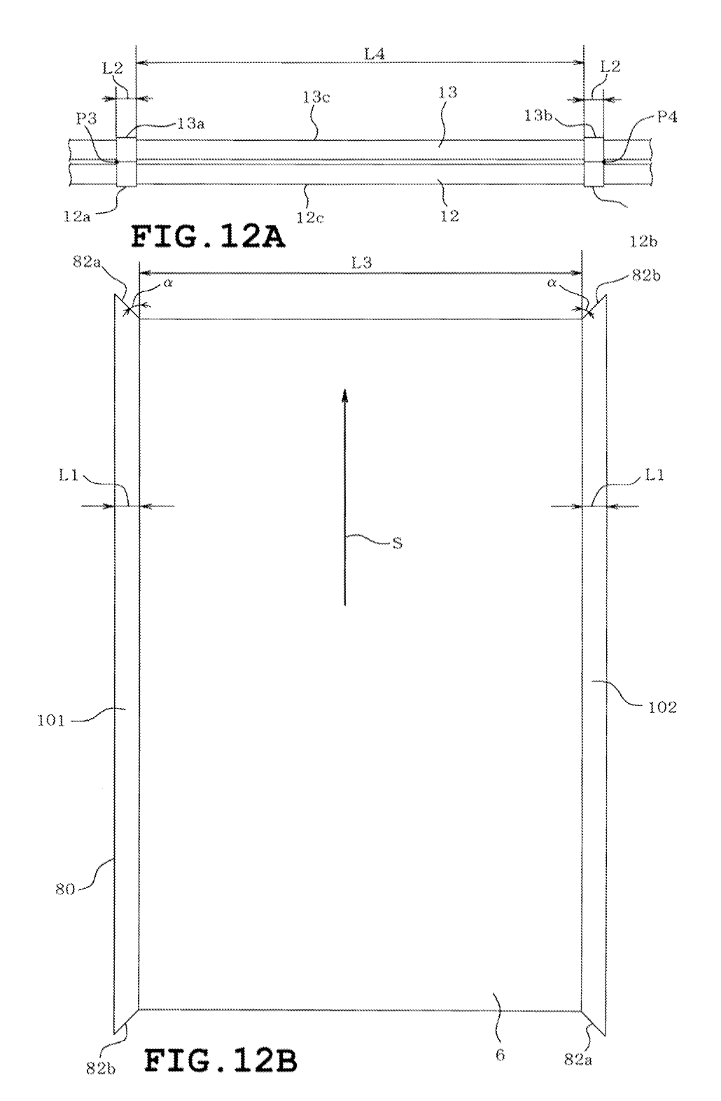

When inserted through the opening 2a of the body cover 2, the holding sheet 10 is held between the driving roller 12 and the pinch roller 13 thereby to be set. The concrete construction of the holding sheet 10, the driving roller 12 and the pinch roller 13 will be described with reference to FIGS. 10A to 11B as well as FIGS. 1 to 9. For the sake of easiness in explanation, FIG. 11A is a front view of the driving roller 12 and the pinch roller 13, and FIG. 11B is a plan view (a top view) of the holding sheet. More specifically, the holding sheet 10 is to be moved inward from the front as shown in FIG. 11A. FIG. 12A is a front view of the driving roller 12 and the pinch roller 13 as well as FIGS. 11A and 11B, as will be described later. FIG. 12B is a plan view (a top view) of the holding sheet 80.

The holding sheet 10 is made of, for example, a synthetic resin and formed into a flat rectangular plate shape, as shown in FIG. 1. The holding sheet 10 is placed opposite the cutter 4 and has a side (a side opposite the cutter 4) on which an adhesive layer 10a is formed by applying an adhesive agent to the holding sheet 10 as shown in FIG. 8. The sheet-like object 6 such as paper, cloth, resin film or the like is removably held by the adhesive layer 10a. The adhesive layer 10a has an adhesion that is set to a small value such that the object 6 can easily be removed from the adhesive layer 10a without breakage of the object 6.

The holding sheet 10 includes a left edge 101 and a right edge 102 to both of which no adhesive agent is applied. More specifically, the left and right edges 101 and 102 are supported portions which are held between the driving roller 12 and the pinch roller 13 thereby to be supported. Each of the right and left edges 102 and 101 has a width L1 that is set to be slightly larger than a width (an axial dimension) L2 of roller members 12a to 13a as will be described later (L1>L2). Furthermore, a dimension between the roller members 12a and 12b and a dimension between roller members 13a and 13b are set to be equal to each other. The dimension is designated by symbol “L4”.

The holding sheet 10 has two bilaterally symmetric inclined portions 71b and 71a formed on the distal end side right and left ends with respect to an insertion direction or distal ends of the right and left edges 102 and 101, respectively. The inclined portions 71a and 71b are inclined inward with respect to the insertion direction (see arrow S in FIGS. 1 and 11B) of the holding sheet 10 into the cutting apparatus 1. In this case, the inclined portions 71a and 71b have the same inclination with respect to the insertion direction of the holding sheet 10 into the cutting apparatus 1. Furthermore, a part of the holding sheet 10 except for the inclined portions 71a and 71b has a width L3 in the right-left direction. The width L3 is set to be slightly smaller than an inner dimension or distance between the roller members 12a and 12b or an inner dimension or distance between the roller members 13a and 13b (L3<L4). The inclined portions 71a and 71b are formed so as to reduce the width of the distal end side with respect to the insertion direction by cutting out the corners of the holding sheet 10 respectively. The adhesive layer 10a has a width in the right-left direction, equal to the aforesaid dimension L3.

The driving roller 12 and the pinch roller 13 extend in the X direction and are rotatably supported on the right and left sidewalls 11a and 11b, as shown in FIGS. 1 to 3. Furthermore, the driving roller 12 and the pinch roller 13 are disposed so as to be parallel with the aforementioned X-Y plane and so as to be vertically arranged. The driving roller 12 is located at the platen 3 side (lower) with respect to the holding sheet 10 to be set and the pinch roller 13 is located at the upper side, as shown in FIG. 9.

In more detail, the driving roller 12 is a support member which is disposed so as to support the holding sheet 10 at platen 3 upper side. The driving roller 12 includes a roller shaft 12c extending between the sidewalls 11a and 11b and a plurality of roller members (two, for example) 12a and 12b mounted on the roller shaft 12c. The roller members 12b and 12a are disposed right and left locations corresponding to right and left edges 102 and 101 of the holding sheet 10 respectively as shown in FIG. 11A. The roller members 12a and 12b have respective outer diameters that are slightly larger than an outer diameter of the roller shaft 12c. The roller members 12a and 12b are provided so that point P1 on an axial end (right end) of the roller member 12a and the inclined portion 71a initially abut on each other when the holding sheet 10 is inserted between the driving roller 12 and the pinch roller 13 and so that point P2 on an axial end (left end) of the roller member 12b and the inclined portion 71b initially abut on each other. The roller member 12a abuts on the left edge 101 of the holding sheet 10 from below and the roller member 12b abuts on the right edge 102 of the holding sheet 10 from below, whereupon the inserted holding sheet 10 is supported. The roller members 12a and 12b have respective surfaces or outer peripheries which are knurled, so that the holding sheet 10 is moved during rotation of the driving roller 12 while the right and left edges 102 and 101 are held so as not to slip.

The pinch roller 13 is a support member which is disposed so as to abut on the holding sheet 10 from above thereby to support the holding sheet 10. The pinch roller 13 includes a roller shaft 13c extending between the sidewalls 11a and 11b and a plurality of (two, for example) roller members 13a and 13b mounted on the roller shaft 13c. The sidewalls 11a and 11b have guide grooves 17a and 17b (see FIGS. 1 and 10B) which are formed so as to vertically extend and through which the roller shaft 13c is inserted, respectively. The pinch roller 13 is guided by the guide grooves 17a and 17b so as to be upwardly movable. The sidewalls 11a and 11b are provided with spring accommodating members 72 which cover the guide grooves 17a and 17b from outside, respectively, as shown in FIGS. 10A and 10B. Each spring accommodating member 72 includes a body 72a accommodating a compression coil spring 73 and a mounting portion 72c formed with a plurality of elongate holes 72b. The body 72a and the holes 72b are formed integrally with each spring accommodating member 72. The holes 72b extend vertically and fixing screws 74 are inserted through the holes 72b respectively. Each spring accommodating member 72 is provided with a contact 73a which is provided on the lower end side of the compression coil spring 73 so as to be brought into contact with the end of the roller shaft 13c.

The vertical position of each spring accommodating member 72 can be adjusted by loosening the screws 74 of the mounting portion 72c thereof. The screws 74 are fastened to fix each spring accommodating 72A after a biasing force of the compression coil spring 73 applied to the roller shaft 13c has been adjusted by adjustment of the vertical position of each spring accommodating member 72. Consequently, pressing forces the driving roller 12 and the pinch roller 13 apply to the holding sheet 10 between the roller members 12a to 13b are rendered adjustable. The holding sheet 10 can securely be held between the roller members 12a to 13b so as to be prevented from shifting against a resistance force (hereinafter, “cutting resistance force”) of the object 6 with relative movement of the cutter 4 and the object 6.

The roller members 13a and 13b of the pinch roller 13 are disposed on the roller shaft 13c so as to be opposed to the roller members 12a and 12b of the driving roller 12 respectively, as shown in FIG. 11A. The roller members 13a and 13b have outer diameters which are slightly larger than an outer diameter of the roller shaft 13c. The roller members 13a and 13b are positioned so that when the holding sheet 10 is inserted between the diving roller 12 and the pinch roller 13, the inclined portion 71a initially abuts on the point P1 of an axial end (a right end) of the roller member 13b and the inclined portion 71b initially abuts on the point P2 of an axial end (a left end) of the roller member 13b. The inserted holding sheet 10 is held between the roller members 12a to 13b when the roller members 13a and 13b abut on the left and right edges 101 and 102 from above respectively. The roller members 13a and 13b have respective surfaces or outer peripheries which are knurled, so that the holding sheet 10 is moved during rotation of the driving roller 12 while the right and left edges 102 and 101 are held so as not to slip.

In the above-described cutting apparatus, a control unit (not shown) for controlling the whole apparatus controls various actuators including the Y-axis motor 15, the X-axis motor 26, the Z-axis motor 34 and the solenoid 57 based on cutting data by execution of a cutting control program, so that a cutting operation is automatically executed on the object 6 on the holding sheet 10.

The cutting apparatus constructed as described above will work as follows. The cutter holder 5 in the apparatus body 1a of the cutting apparatus 1 occupies a raised position before the cutting of the object 6 starts. In this state, the user affixes, for example, a cloth as the object 6 to the adhesive layer 10a, so that the cloth is held on the holding sheet 10. The user then inserts the holding sheet 10 into the opening 2a of the apparatus body 1a to set the holding sheet. In this case, the user moves the cloth rearward (in the direction of arrow S in FIG. 1) while causing the position of the holding sheet 10 in the right-left direction to correspond with the positioning lines W1 and W2. The user then inserts the left and right edges 101 and 102 of the holding sheet 10 between the driving roller 12 and the roller members 12a to 13b of the pinch roller 13. In this case, the pinch roller 13 needs to be moved upward by an amount of a thickness of the holding sheet 10 against the biasing force of the compression coil spring 73. In this regard, the holding sheet 10 is formed with inclined portions 71a and 71b, which initially abut on the points P1 and P2 of the ends of the roller members 12a to 13b. Thus, since the initial abutment is a point contact of points P1 and P2, the holding sheet 10 can be inserted smoothly.

The holding sheet 10 is thus inserted into the apparatus body 1a thereby to be set. In this state, the left and right edges 101 and 102 of the holding sheet 10 are held by the roller members 12a to 13b. The user then operates the operation switches to select desired one of cutting data stored in the storage device (not shown) provided in the apparatus body 1a, so that the cutting operation is executed based on the selected cutting data.

In the cutting operation, the Y-axis and X-axis motors 15 and 26 are driven so that the object 6 is moved to a cutting start point. The solenoid 57 is driven to press the pressing member 56 against the object 6. Furthermore, the Z-axis motor 34 is driven so that the cutter holder 5 is moved to the lowered position and so that the blade edge 4c of the cutter 4 is caused to pass through the cutting start point of the object 6. The Y-axis motor 15 and the X-axis motor 26 are driven on the basis of the cutting data so that the cutter 4 and the holding sheet 10 are moved relative to each other, whereby the object 6 is cut. In the cutting, since the holding sheet 10 is securely held between the roller members 12a to 13b by the biasing force of the compression coil spring 73, the holding sheet 10 can be prevented from shifting when subjected to the cutting resistance force. Furthermore, since the left and right edges 101 and 102 are supported between the roller members 12a to 13b, the holding sheet 10 can be inserted into the apparatus body 1a reliably and smoothly regardless of the thickness of the object 6 and can stably be moved.

The object 6 can be pressed by the pressing member 56 actuated by the solenoid 57 and held by the adhesive layer 10a of the holding sheet 10 so as not to shift during the cutting. Furthermore, the pressing member is moved relative to the object 6. However, since the contact portion 56f of the pressing member 56 is made of a material having a lower frictional coefficient than the object 6, a frictional force produced between the contact portion 56f and the object 6 can be reduced as much as possible. Consequently, the object 6 can be prevented from displacement due to the frictional force, whereupon the object 6 can be held more reliably.

As described above, the cutting apparatus according to the embodiment includes the holding sheet 10 which is inserted into the apparatus body 1a with the object 6 being held by the holding sheet 10, and the driving roller 12 and the pinch roller 13 both abutting on the holding sheet 10 in the direction differing from the insertion direction thereby to support the holding sheet 10. The holding sheet 10 is a supported portion supported by the driving roller 12 and pinch roller 13 and has the right and left edges 102 and 101 provided with the inclined portions 71b and 71a inclined relative to the insertion direction. The inclined portions 71a and 71b are adapted to initially abut on the driving roller 2 and pinch roller 13 when the holding sheet 10 is inserted into the apparatus body.

The driving roller 12 and the pinch roller 13 abut on the holding sheet 10 in the direction differing from the insertion direction (arrow S) to support the holding sheet 10. Since the driving roller 12 and the pinch roller 13 initially abut on the inclined portions 71a and 71b of the holding sheet 10, the holding sheet 10 can be inserted smoothly. Accordingly, the holding sheet 10 can reliably be supported by the driving roller 12 and the pinch roller 13, whereupon the holding sheet 10 can be transferred stably.

The driving roller 12 and the pinch roller 13 include the respective roller members 12a to 13b which hold the right and left edges 102 and 101 to move to move the holding sheet 10 in the insertion direction (arrow S). According to this, the right and left edges 102 and 101 is held by the roller members 12a to 13b and the holding sheet 10 is moved while the right and left edges being held by the roller members 12a to 13b. Accordingly, the holding sheet 10 can be smoothly be inserted by rotation of the roller members 12a to 13b.

The roller members 12a to 13b are located at the position where the ends of the roller members 12a to 13b initially abut on the inclined portions 71a and 71b when the holding sheet 10 is inserted into the apparatus body 1a. According to this, the holding sheet 10 can be inserted further smoothly since the ends of the roller members 12a to 13b initially abut on the inclined portions 71a and 71b. The inclined portions 71a and 71b are provided on the right and left ends of the holding sheet 10 respectively and the roller members 12a to 13b are located at the positions corresponding to the inclined portions 71a and 71b respectively. Consequently, the holding sheet 10 can smoothly be inserted in a balanced manner.

### Other Embodiments

FIGS. 12A to 16 illustrate second to sixth embodiments. Identical or similar parts in the second embodiment are labeled by the same reference symbols as those in the first embodiment, and description of these parts will be eliminated. Only the difference between the first and second embodiments will be described.

A holding sheet 80 in the second embodiment as shown in FIG. 12B differs from the holding sheet 10 in the first embodiment in the following respects. The holding sheet 80 has inclined portions 82a and 82b formed on both ends of an upper side thereof and inclined portions 82a and 82b formed on both ends of a lower side thereof. The inclined portions 82a and 82b of the upper side and the lower side are symmetric. More specifically, the inclined portions 82a and 82b are formed by extending four corners of the holding sheet 80 in the Y direction from the left and right ends 101 and 102 respectively. The inclined portions 82a and 82b are inclined so as to be open outward with respect to the insertion direction of the holding sheet 80. The holding sheet 80 has a width (L1+L3+L1) with respect to the right-left direction of the holding sheet 80. The width is set to be larger than outer dimensions of the inclined portions 82a and 82b or outer dimensions (L2+L4+L2) of the roller members 13a and 13b. Accordingly, an axial end point P3 (a left end) and the inclined portion 82a initially abut on each other regarding the roller member 12a, and an axial end point P4 (a right end) and the inclined portion 82b initially abut on each other regarding the roller member 12b. The point P3 and the inclined portion 82a initially abut on each other regarding the roller member 13a, and the point P4 and the inclined portion 82b initially abut on each other regarding the roller member 13b.

When the holding sheet 80 is set on the apparatus body 1a of the cutting apparatus 1 constructed as described above, the inclined portions 82a and 82b initially abut on the driving roller 12 and the pinch roller 13. Consequently, the holding sheet 80 can be inserted smoothly. Thus, the second embodiment can achieve the same advantageous effect as the first embodiment. Furthermore, the holding sheet 10 can also be inserted smoothly even when the holding sheet 80 is inserted into the apparatus body 1a back to front or in the direction obtained by 180-degree inverting the insertion direction shown by arrow S. This can improve the usability of the apparatus.

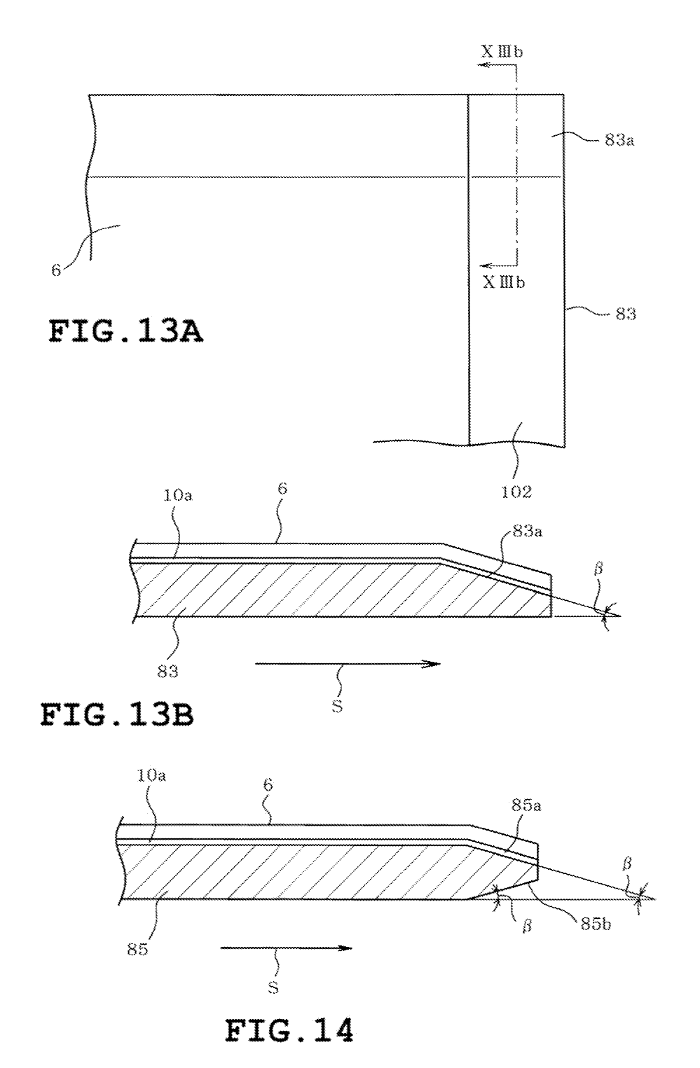

FIGS. 13A and 13B illustrate a third embodiment. The holding sheet 83 in the third embodiment differs from the holding sheet 10 in the first embodiment in the following respects. The holding sheet 83 has an insertion-side side formed with an inclined portion 83a. The inclined portion 83a is an inclined surface (a chamfered surfaced) that is inclined downward in the insertion direction. The inclined portion 83a is downwardly inclined by a predetermined angle β relative to the insertion direction of the holding sheet 83 (see arrow S in FIG. 13B).

According to the above-described construction, the inclined portion 83a initially abuts on the roller members 13a and 13b of the upper pinch roller 13 when the holding sheet 83 is inserted into the apparatus body 1a. Consequently, the holding sheet 83 can smoothly be inserted between the driving roller 12 and the pinch roller 13 from the side with the inclined portion 83a.

FIG. 14 illustrates a fourth embodiment. A holding sheet 85 in the fourth embodiment differs from the holding sheet 83 in the third embodiment in the following respects. The holding sheet 85 has an insertion-side side having an inclined portion 85a on a top surface and another inclined portion 85b on an underside. The inclined portion 85b is an inclined surface (a chamfered surface) that is inclined upward in the insertion direction in the underside of the holding sheet 85. The inclined portion 85b is upwardly inclined by the predetermined angle β relative to the insertion direction of the holding sheet 85 (see arrow S in FIG. 13B).

According to the above-described construction, when the holding sheet 85 is inserted into the apparatus body 1a, the inclined portion 85a initially abuts on the roller members 13a and 13b of the pinch roller 13, and the inclined portion 85b initially abuts on the roller members 12a and 12b of the driving roller 12. Consequently, the holding sheet 85 can smoothly be inserted between the driving roller 12 and the pinch roller 13 from the side with the inclined portions 85a and 85b.

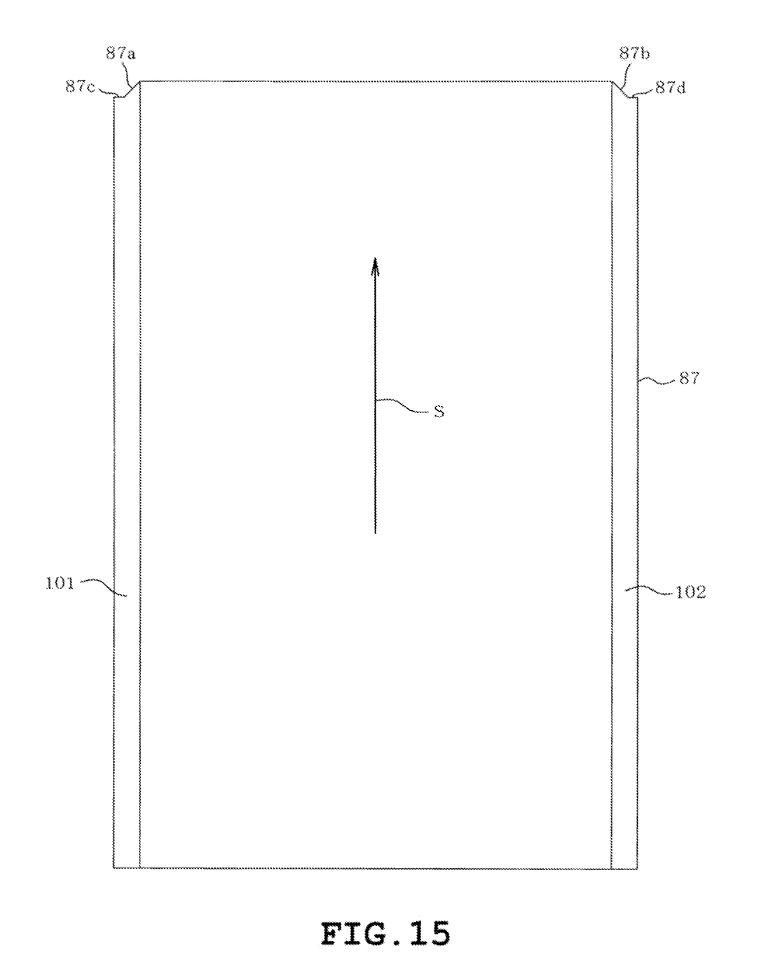

FIG. 15 illustrates a fifth embodiment. A holding sheet 87 in the fifth embodiment has an inclined portion which is terminated in the middle. In this case, an inclined portion 87a is formed only in a part of the holding sheet 87 initially abutting on the point P1 on the end of the roller member 12a or 13a, and a corner 87c is formed outside the inclined portion 87a so as to be continuous to the inclined portion 87a. An inclined portion 87b is formed only in another part of the holding sheet 87 initially abutting on the point P2 on the end of the roller member 12a or 13a, and a corner 87d is formed outside the inclined portion 87b so as to be continuous to the inclined portion 87b.

In the above-described construction, too, when the holding sheet 87 is inserted into the apparatus body 1a, the inclined portion 87a initially abuts on the points P2 on the ends of the roller members 12a and 13a. Consequently, the holding sheet 87 can smoothly be inserted. Thus, the fifth embodiment can achieve the same advantageous effect as the first embodiment. The lengths of the inclined portions 87a and 87b may be suitably set in a relative positional relation with the roller members 12a to 13b.

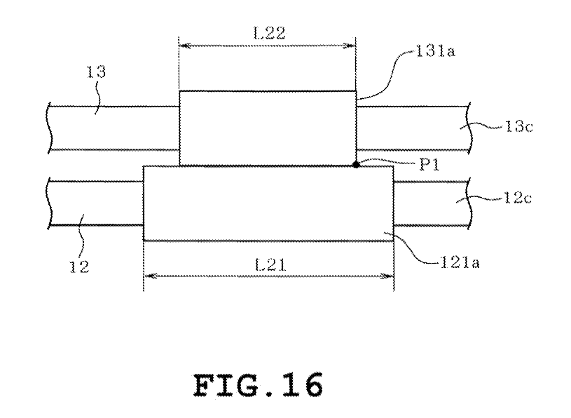

FIG. 16 illustrates a sixth embodiment. The left roller member 121a of the driving roller 12 has a width L21 that is set to be larger than a width L22 of the left roller member 131a of the pinch roller 13 (L21>L22). The right roller members 121b and 131b also have the same configuration although this is not shown. According to the construction, when the holding sheet 10 is inserted into the apparatus body 1a, the inclined portion 71a initially abuts on the point P1 on the right end of the roller member 131a of the pinch roller 13, and the inclined portion 71b initially abuts on the point P2 on the left end of the roller member 131b. Consequently, the holding sheet 10 can smoothly be inserted. Thus, the sixth embodiment can achieve the same advantageous effect as the first embodiment. More specifically, when the holding sheet 10 is inserted between a pair of roller members, the inclined portions 71 and 71b of the holding sheet 10 should initially abut on the end of the roller members.

The above-described embodiments should not be restrictive but may be modified or expanded as follows. Although each embodiment has been applied to the cutting apparatus as the cutting plotter, embodiments may be various devices and apparatuses each having a cutting function.

The holding sheet 10 as shown in FIG. 11B may be provided with the inclined portion on the underside thereof as in the holding sheet 80 as shown in FIG. 12B. More specifically, the inclined portions may be provided on four corners of the holding sheet 10 respectively. Furthermore, the inclined portions 71a and 71b may be combined with the top side inclined portion 85a and/or the inclined portion 85b. Furthermore, although the inclined portions (or inclined surfaces) are linear in the foregoing embodiments, the inclined portions (or surfaces) may be curved (arc-shaped), instead. Additionally, although the whole holding member is rectangular in each embodiment, various shapes of holding members may be employed.

The adhesive layer 10a may be formed on the entire upper surface of the holding sheet 10. In this case, when thin plate-shaped members made of a metal or resin may be affixed to parts corresponding to the right and left edges 102 and 101, the plate-shaped members can serve as supported portions.

The foregoing description and drawings are merely illustrative of the present disclosure and are not to be construed in a limiting sense. Various changes and modifications will become apparent to those of ordinary skill in the art. All such changes and modifications are seen to fall within the scope of the appended claims.

What is claimed is:

1. A cutting apparatus which includes an apparatus body and wherein a cutting blade and an object to be cut are moved relative to each other so that the object is cut by the cutting blade, the cutting apparatus comprising:
a holding member which is inserted into the apparatus body while holding the object; and
a supporting member which is provided on the apparatus body and abuts on the holding member in a direction which differs from an insertion direction in which the holding member is inserted into the apparatus body, thereby supporting the holding member, wherein:
the holding member has a supported portion which is supported by the supporting member and provided with an inclined portion which is inclined to the insertion direction; and
the holding member is configured so that the inclined portion thereof initially abuts on the supporting member.

2. The apparatus according to claim 1, wherein the supporting member includes a rolling member which holds the supported portion to move the holding member in the insertion direction.

3. The apparatus according to claim 2, wherein the rolling member is positioned so that an end thereof initially abuts on the inclined portion in insertion of the holding member into the apparatus.

4. The apparatus according to claim 2, wherein the holding member comprises a flat plate-shaped member which is in general formed into a rectangular shape having at least one side with two ends formed with the inclined portions respectively, and the rolling member is located at a position corresponding to the inclined portions.

5. The apparatus according to claim 3, wherein the holding member comprises a flat plate-shaped member which is in general formed into a rectangular shape having at least one side with two ends formed with the inclined portions respectively, and the rolling member is located at a position corresponding to the inclined portions.

6. A holding member for use with a cutting apparatus in which a cutting blade and an object to be cut are moved relative to each other so that the object is cut by the cutting blade, the holding member comprising:
a supported portion supported by a supporting member provided on the holding member, the supported portion being supported by abutting the supporting member thereon from a direction differing from the insertion direction; and
an inclined portion which is provided on the supported member so as to be inclined to the insertion direction, wherein the inclined portion initially abuts on the supporting member when the holding member is inserted into the cutting device.

7. The holding member according to claim 6, which comprises a flat plate-shaped member which is in general formed into a rectangular shape having at least one side with two ends formed with the inclined portions respectively.
